(19) United States
(12) Patent Application Publication
(10) Pub. No.: US 2026/0121567 A1
(43) Pub. Date: Apr. 30, 2026

(54) PHASE CORRECTION DEVICE AND PHASE CORRECTION METHOD FOR SYNCHRONIZED PWM CONTROL

(71) Applicant: MEIDENSHA CORPORATION, Shinagawa-ku, Tokyo (JP)

(72) Inventors: Sho SHIBATA, Tokyo (JP); Takato NAKAI, Tokyo (JP)

(73) Assignee: MEIDENSHA CORPORATION, Shinagawa-ku, Tokyo (JP)

(21) Appl. No.: 19/164,528

(22) PCT Filed: Mar. 8, 2024
(86) PCT No.: PCT/JP2024/009058

§ 371 Date: Sep. 11, 2025

(30) Foreign Application Priority Data
Mar. 20, 2023 (JP) 2023-043852

(51) Int. Cl. H02P 27/08; H02M 7/5395

(52) U.S. Cl. CPC H02P 27/085; H02M 7/5395

(57) ABSTRACT

A phase correction device includes a phase error detection unit detecting an error between phases of an output voltage command of a power converter under synchronous PWM control and a carrier signal of carrier frequency in the synchronous PWM control, and a first carrier frequency calculation unit calculating a first phase correction carrier frequency for phase error correction when the phase error exceeds a set threshold value. During operation under synchronous PWM control, the carrier frequency in the synchronous PWM control is set. When the detected phase error exceeds the threshold value, the carrier frequency is changed and set to the first phase correction carrier frequency for a set period. At a Kp^{th} cycle or after Kp cycles of the carrier signal (Kp is the number of pulses of the signal per output voltage command cycle), the first phase correction carrier frequency is returned to the carrier frequency.

### TECHNICAL FIELD

The present invention relates to a method of correcting a phase error between an output voltage command and a carrier signal in synchronous PWM control in a power converter that drives a motor or the like.

### BACKGROUND ART

As a control method of generating a desired output voltage or current in a power converter such as an inverter, there is a PWM control method which turns on and off switching elements in the power converter on the basis of a comparison between an output voltage command and a carrier signal.

Patent Document 1 proposes a method of suppressing a current shock and a torque shock upon switching, by providing an appropriate switching condition when switching from asynchronous PWM control to synchronous PWM control and when switching the number of pulses in synchronous PWM control. This method is characterized in that the switching condition is that a phase difference between a carrier signal and an output voltage command before and after the switching is within a certain range.

Patent Document 2 proposes a method of determining a timing of changing a carrier frequency in synchronous PWM control. This method is characterized in that a certain threshold value is set for a phase difference between an output (rotor) electrical angle and a carrier signal, and when exceeding this threshold value, a change in the carrier frequency is permitted.

### CITATION LIST

### Patent Document

Patent Document 1: Japanese Unexamined Patent Application Publication No. 2010-051129
Patent Document 2: Japanese Unexamined Patent Application Publication No. 2010-098868

### SUMMARY OF THE INVENTION

### Technical Problem

The important thing about the synchronous PWM control is that a phase of the output voltage command and a phase of the carrier signal synchronize with each other, which maintains the symmetry of the output voltage pulse, thereby solving a problem such as low-frequency pulsation of the output.

Patent Document 1 proposes a method in which when switching from asynchronous PWM control to synchronous PWM control or when switching the number of pulses in synchronous PWM control, the switching condition is that a phase difference between a carrier signal (a triangular wave) and an output voltage command before and after the switching is within a certain range.

When switching from asynchronous PWM control to synchronous PWM control, it is determined whether or not the phase difference between the output voltage command and the carrier signal is within a range of approximately +5° of a defined reference value. If the determination is not satisfied, the asynchronous PWM control is continued, whereas if the determination is satisfied, the asynchronous PWM control is switched to the synchronous PWM control.

When switching the number of pulses in synchronous PWM control, if the number of pulses is an odd number, the phase of the output voltage command and the phase of the carrier signal maintain a synchronous state. Therefore, in this case, the determination at the time of the switching is not necessary. In this way, in Patent Document 1, when the determination is not satisfied, a delay occurs in the switching from asynchronous PWM control to synchronous PWM control. In addition, an occurrence of the phase error during the driving under the synchronous PWM control is not taken into consideration.

Patent Document 2 proposes a method for stably perform synchronous PWM control even when a rotor rotation speed of a motor, which is a load, suddenly changes. FIG. 1 illustrates an example of a phase relationship between the carrier signal and the rotor electrical angle. A phase of the carrier signal is θ_{CA}, and a phase of the rotor electrical angle is θₘ. The rotor electrical angle is sampled every one cycle of the carrier signal (θₘ₁ to θₘ₅ in FIG. 1). Each phase of the sampled rotor electrical angle is compared with defined upper and lower threshold values, and when exceeding the threshold value, the carrier frequency is changed.

Neither Patent Document 1 nor Patent Document 2 mentions a phase error between the output voltage (or the output voltage command) and the carrier signal when an output frequency in synchronous PWM control is constant. Since the carrier frequency in synchronous PWM control is an integer multiple of the output frequency at that time, ideally, once the phases of the output voltage and the carrier signal are synchronized, the synchronous state of the phases is maintained as long as the output frequency does not fluctuate.

However, in an actual device, since a resolution of the carrier frequency is determined by a clock frequency of a controller such as a CPU and a FPGA (since a carrier cycle is limited to an integer multiple of a clock cycle), the carrier frequency is not necessarily an integer multiple of the output frequency. When the carrier frequency is deviated from an integer multiple of the output frequency in this way, even if the output frequency is constant, the phase error between the output voltage and the carrier signal increases with time, and the synchronous state cannot be maintained.

For instance, consider synchronous PWM control in which the number of pulses is 9 (9 pulses) when the output frequency is 600 Hz. The carrier frequency must be 5400 Hz, which is a multiplication value of the output frequency and the number of pulses. Here, it is assumed that the clock frequency of the controller is 200 MHz, and the carrier signal is generated by counting the clock frequency. When calculating 200M/5400 with decimal places of 200M/5400 being discarded, 5400 Hz is derived by 37037 counts of 200 MHz of the clock frequency.

However, in actual fact, 200M/37037=5400.0054 Hz. This error of 0.0054 Hz results in a phase shift of approximately 0.00036 degrees per cycle of the output voltage at a frequency of 600 Hz. Although the phase error per cycle is minute, for instance, when the operation is performed for one minute at a frequency of 600 Hz, the phase error is 12.96 degrees.

In this way, even if the output frequency is constant, the phase error between the output voltage and the carrier signal gradually increases, and as a consequence, the symmetry of the output pulse cannot be maintained.

The present invention was made to solve the above problem. An object of the present invention is to provide a phase correction device for synchronous PWM control which is capable of eliminating the phase error between the output voltage command and the carrier frequency and maintaining the synchronous state during operation under the synchronous PWM control.

### Solution to Problem

To solve the above problem, a phase correction device, described in claim 1, for synchronous PWM control for controlling a single-phase or three-phase power converter with a phase of an output voltage command and a phase of a carrier signal being synchronized with each other, the phase correction device comprises: a phase error detection unit configured to detect an error between a phase of the output voltage command of the power converter operating under the synchronous PWM control and a phase of the carrier signal of a carrier frequency in the synchronous PWM control; a first carrier frequency calculation unit configured to, when the detected phase error exceeds a set threshold value, calculate a first phase correction carrier frequency for correcting the phase error, and a carrier frequency setting unit configured to set the carrier frequency in the synchronous PWM control during operation under the synchronous PWM control, and when the detected phase error exceeds the set threshold value, change and set the carrier frequency of the carrier signal to the first phase correction carrier frequency for a set period.

The phase correction device, described in claim 2, for the synchronous PWM control as described in claim 1, further comprises a second carrier frequency calculation unit configured to determine whether or not the calculated first phase correction carrier frequency exceeds an upper limit of the carrier frequency of the power converter, and when the first phase correction carrier frequency exceeds the upper limit, calculate a second phase correction carrier frequency for correcting the phase error, which does not exceed the upper limit of the carrier frequency of the power converter. Furthermore, the carrier frequency setting unit is configured to, when the first phase correction carrier frequency does not exceed the upper limit of the carrier frequency of the power converter, change and set the carrier frequency of the carrier signal to the first phase correction carrier frequency for the set period, and when the first phase correction carrier frequency exceeds the upper limit of the carrier frequency of the power converter, change and set the carrier frequency of the carrier signal to the second phase correction carrier frequency for another set period.

The phase correction device, described in claim 3, for the synchronous PWM control as described in claim 1, further comprises a third carrier frequency calculation unit configured to determine whether or not a difference between the calculated first phase correction carrier frequency and the carrier frequency having been set by the carrier frequency setting unit exceeds a set variation range limit value, and when the difference exceeds the variation range limit value, calculate a third phase correction carrier frequency by adding or subtracting the variation range limit value to or from the carrier frequency having been set by the carrier frequency setting unit. Furthermore, the carrier frequency setting unit is configured to, when the detected phase error exceeds the set threshold value but the difference between the first phase correction carrier frequency and the carrier frequency having been set by the carrier frequency setting unit does not exceed the variation range limit value, change and set the carrier frequency of the carrier signal to the first phase correction carrier frequency for the set period, and when the detected phase error exceeds the set threshold value and also the difference between the first phase correction carrier frequency and the carrier frequency having been set by the carrier frequency setting unit exceeds the variation range limit value, change and set the carrier frequency of the carrier signal to the third phase correction carrier frequency for another set period.

In the phase correction device, described in claim 4, for the synchronous PWM control as described in claim 1, the carrier frequency setting unit is configured to set a carrier frequency f_{c} in the synchronous PWM control, as f_{c}=Kp×f_{c} (Kp is the number of pulses of the carrier signal per cycle of the output voltage command, and fₒ is the output frequency of the power converter). The phase error detection unit is configured to define a synchronous phase θ′_{V0} of the phase of the output voltage command at a set reference point when the phases of the output voltage command and the carrier signal are synchronized with each other and the number of pulses is Kp, by the following expression (3), and

$$\begin{matrix}[ Expression 3 ] & \\ {θ}_{v 0}^{′} = \frac{360}{{K}_{p} \times 4} [ deg ] & ( 3 )\end{matrix}$$

detect an error between a detected phase Ovo of the output voltage command at the set reference point and the synchronous phase θ′_{V0} defined by the expression (3). The first carrier frequency calculation unit is configured to calculate a first phase correction carrier frequency f_{cθ} by the following expressions (4) and (5).

$$\begin{matrix}[ Expression 4 ] & \\ {f}_{c θ} = \frac{360 \times {f}_{o}}{360 - {θ}_{e r r}} \times {K}_{p} [ Hz ] & ( 4 )\end{matrix}$$

$$\begin{matrix}[ Expression 5 ] & \\ {θ}_{e r r} = {θ}_{v 0} - {θ}_{v 0}^{′} [ deg ] & ( 5 )\end{matrix}$$

(here, θₑᵣᵣ is a difference between the synchronous phase θ′_{V0} and the detected phase θ_{V0}). The period for which the carrier frequency of the carrier signal is changed and set to the first phase correction carrier frequency by the carrier frequency setting unit is Kp cycles of the carrier signal.

In the phase correction device, described in claim 5, for the synchronous PWM control as described in claim 2, the carrier frequency setting unit is configured to set a carrier frequency f_{c} in the synchronous PWM control, as f_{c}=Kp×f_{c} (Kp is the number of pulses of the carrier signal per cycle of the output voltage command, and fₒ is the output frequency of the power converter). The phase error detection unit is configured to define a synchronous phase θ′_{V0} of the phase of the output voltage command at a set reference point when the phases of the output voltage command and the carrier signal are synchronized with each other and the number of pulses is Kp, by the following expression (3), and

$$\begin{matrix}[ Expression 3 ] & \\ {θ}_{v 0}^{′} = \frac{360}{{K}_{p} \times 4} [ deg ] & ( 3 )\end{matrix}$$

detect an error between a detected phase Ovo of the output voltage command at the set reference point and the synchronous phase θ′_{V0} defined by the expression (3). The first carrier frequency calculation unit is configured to calculate a first phase correction carrier frequency f_{c}θ by the following expressions (4) and (5).

$$\begin{matrix}[ Expression 4 ] & \\ {f}_{c θ} = \frac{360 \times {f}_{o}}{360 - {θ}_{e r r}} \times {K}_{p} [ Hz ] & ( 4 )\end{matrix}$$

$$\begin{matrix}[ Expression 5 ] & \\ {θ}_{e r r} = {θ}_{v 0} - {θ}_{v 0}^{′} [ deg ] & ( 5 )\end{matrix}$$

(here, θₑᵣᵣ is a difference between the synchronous phase θ′_{V0} and the detected phase θ_{V0}). The second carrier frequency calculation unit is configured to calculate a second phase correction carrier frequency f_{cθ} by the following expressions (6) and (5).

$$\begin{matrix}[ Expression 6 ] & \\ {f}_{c θ} = \frac{360 \times {f}_{o}}{360 - {θ}_{e r r}} \times ( {K}_{p} - 1 ) [ Hz ] & ( 6 )\end{matrix}$$

$$\begin{matrix}[ Expression 5 ] & \\ {θ}_{e r r} = {θ}_{v 0} - {θ}_{v 0}^{′} [ deg ] & ( 5 )\end{matrix}$$

(here, θₑᵣᵣ is a difference between the synchronous phase θ′_{V0} and the detected phase evo). The period for which the carrier frequency of the carrier signal is changed and set to the first phase correction carrier frequency by the carrier frequency setting unit is Kp cycles of the carrier signal, and the another period for which the carrier frequency of the carrier signal is changed and set to the second phase correction carrier frequency by the carrier frequency setting unit is (Kp−1) cycles of the carrier signal.

In the phase correction device, described in claim 6, for the synchronous PWM control as described in claim 3, the carrier frequency setting unit is configured to set a carrier frequency f_{c} in the synchronous PWM control, as f_{c}=Kp×fₒ (Kp is the number of pulses of the carrier signal per cycle of the output voltage command, and fₒ is the output frequency of the power converter). The phase error detection unit is configured to define a synchronous phase θ′_{V0} of the phase of the output voltage command at a set reference point when the phases of the output voltage command and the carrier signal are synchronized with each other and the number of pulses is Kp, by the following expression (3), and

$$\begin{matrix}[ Expression 3 ] & \\ {θ}_{v 0}^{′} = \frac{360}{{K}_{p} \times 4} [ deg ] & ( 3 )\end{matrix}$$

detect an error between a detected phase Ovo of the output voltage command at the set reference point and the synchronous phase θ′_{V0} defined by the expression (3). The first carrier frequency calculation unit is configured to calculate a first phase correction carrier frequency f_{c}θ by the following expressions (4) and (5).

$$\begin{matrix}[ Expression 4 ] & \\ {f}_{c θ} = \frac{360 \times {f}_{o}}{360 - {θ}_{e r r}} \times {K}_{p} [ Hz ] & ( 4 )\end{matrix}$$

$$\begin{matrix}[ Expression 5 ] & \\ {θ}_{e r r} = {θ}_{v 0} - {θ}_{v 0}^{′} [ deg ] & ( 5 )\end{matrix}$$

(here, θₑᵣᵣ is a difference between the synchronous phase θ′_{V0} and the detected phase evo). The third carrier frequency calculation unit is configured to calculate a third phase correction carrier frequency f′_{cθ} by the following expression (7).

$$\begin{matrix}[ Expression 7 ] & \\ {f}_{c θ}^{′} = {f}_{c \_ z} \pm {f}_{lim} [ Hz ] & ( 7 )\end{matrix}$$

(here, f_{C_Z} is a carrier frequency currently set by the carrier frequency setting unit, and fₗᵢₘ is the variation range limit value of the carrier frequency). Addition or subtraction of fₗᵢₘ in the expression (7) is determined by a magnitude relationship indicated in the following expression (8).

$$[ Expression 8 ]$$

$$\{ \begin{matrix}{f}_{c \_ z} > {f}_{c θ} : {f}_{lim} & SUBTRACTION \\ {f}_{c \_ z} < {f}_{c θ} : {f}_{lim} & ADDITION\end{matrix} \qquad ( 8 )$$

The period for which the carrier frequency of the carrier signal is changed and set to the first phase correction carrier frequency by the carrier frequency setting unit, and the another period for which the carrier frequency of the carrier signal is changed and set to the third phase correction carrier frequency by the carrier frequency setting unit are both Kp cycles of the carrier signal.

A phase correction method, described in claim 7, for synchronous PWM control for controlling a single-phase or three-phase power converter with a phase of an output voltage command and a phase of a carrier signal being synchronized with each other, the phase correction method comprises: a phase error detection step of detecting an error between a phase of the output voltage command of the power converter operating under the synchronous PWM control and a phase of the carrier signal of a carrier frequency in the synchronous PWM control, by a phase error detection unit; a first carrier frequency calculation step of, when the detected phase error exceeds a set threshold value, calculating a first phase correction carrier frequency for correcting the phase error, by a first carrier frequency calculation unit, and a carrier frequency calculation and setting step of calculating and setting the carrier frequency in the synchronous PWM control during operation under the synchronous PWM control, and a carrier frequency setting change step of, when the phase error detected in the phase error detection step exceeds the set threshold value, changing and setting the carrier frequency of the carrier signal to the first phase correction carrier frequency for a set period, by a carrier frequency setting unit.

The phase correction method, described in claim 8, for the synchronous PWM control as described in claim 7, further comprises a second carrier frequency calculation step of determining whether or not the calculated first phase correction carrier frequency exceeds an upper limit of the carrier frequency of the power converter, and when the first phase correction carrier frequency exceeds the upper limit, calculating a second phase correction carrier frequency for correcting the phase error, which does not exceed the upper limit of the carrier frequency of the power converter, by a second carrier frequency calculation unit. Furthermore, in the carrier frequency setting change step, when the first phase correction carrier frequency does not exceed the upper limit of the carrier frequency of the power converter, the carrier frequency of the carrier signal is changed and set to the first phase correction carrier frequency for the set period, and when the first phase correction carrier frequency exceeds the upper limit of the carrier frequency of the power converter, the carrier frequency of the carrier signal is changed and set to the second phase correction carrier frequency for another set period.

The phase correction method, described in claim 9, for the synchronous PWM control as claimed in claim 7, further comprises a third carrier frequency calculation step of determining whether or not a difference between the calculated first phase correction carrier frequency and the carrier frequency having been set by the carrier frequency setting unit exceeds a set variation range limit value, and when the difference exceeds the variation range limit value, calculating a third phase correction carrier frequency by adding or subtracting the variation range limit value to or from the carrier frequency having been set by the carrier frequency setting unit, by a third carrier frequency calculation unit. Furthermore, in the carrier frequency setting change step, when the detected phase error exceeds the set threshold value but the difference between the first phase correction carrier frequency and the carrier frequency having been set by the carrier frequency setting unit does not exceed the variation range limit value, the carrier frequency of the carrier signal is changed and set to the first phase correction carrier frequency for the set period, and when the detected phase error exceeds the set threshold value and also the difference between the first phase correction carrier frequency and the carrier frequency having been set by the carrier frequency setting unit exceeds the variation range limit value, the carrier frequency of the carrier signal is changed and set to the third phase correction carrier frequency for another set period.

### Effects of Invention

According to the inventions of claims 1 to 9, the phase error is detected and the carrier frequency is appropriately changed during the operation, thereby eliminating the phase error and maintaining the synchronous state. Since the symmetry of the output voltage pulse is also maintained, a beat phenomenon of the output etc. can be suppressed.

In claims 1, 4 and 7, the calculated phase correction carrier frequency may be a value that exceeds the upper limit of the carrier frequency which is limited by the power converter. In such a case, if the carrier frequency is set to the upper limit, the phase correction cannot be performed appropriately. According to the inventions described in claims 2, 5 and 8, when the calculated phase correction carrier frequency exceeds the upper limit, the carrier frequency that does not exceed the upper limit and that allows the phase correction is recalculated. It is therefore possible to perform the phase correction regardless of the upper limit of the carrier frequency of the power converter.

In claims 1, 4 and 7, a difference between the calculated phase correction carrier frequency and a currently set carrier frequency may become large. If a range of change in the carrier frequency is large, a current amplitude becomes excessive upon switching the carrier frequency. According to the inventions described in claims 3, 6 and 9, the limit is placed on the range of change in the carrier frequency, and a steep change in the carrier frequency is suppressed. It is therefore possible to change the carrier frequency and perform the phase correction while suppressing an increase in the current amplitude.

### BRIEF DESCRIPTION OF THE DRAWINGS

FIG. 1 is an explanatory diagram showing a phase relationship between a carrier signal and a rotor electrical angle in synchronous PWM control.

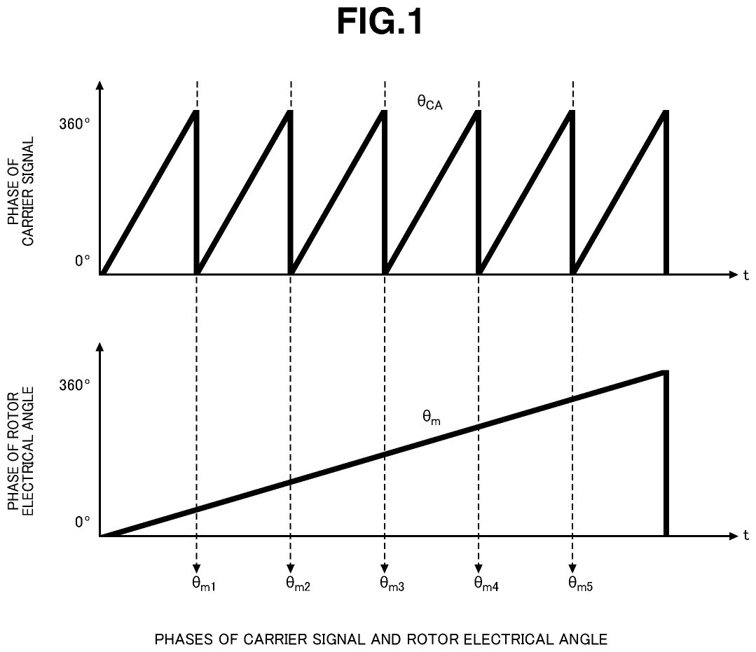

FIG. 2 is a configuration diagram showing an example of a system to which the present invention is applied.

FIG. 3 is an explanatory diagram showing an example of a carrier frequency with respect to an output frequency, used in PWM control.

FIG. 4 is an explanatory diagram showing phase sampling of an output voltage command synchronized with the carrier signal.

FIG. 5 is an explanatory diagram showing transition of the carrier frequency by a phase correction method according to the present invention.

FIG. 6 is a flow chart of carrier frequency setting according to a first embodiment of the present invention.

FIG. 7 is a flow chart of carrier frequency setting according to a second embodiment of the present invention.

FIG. 8 is a flow chart of carrier frequency setting according to a third embodiment of the present invention.

### EMBODIMENTS FOR CARRYING OUT THE INVENTION

Embodiments of the present invention will be described in detail below with reference to the drawings. However, the present invention is not limited to the following embodiments.

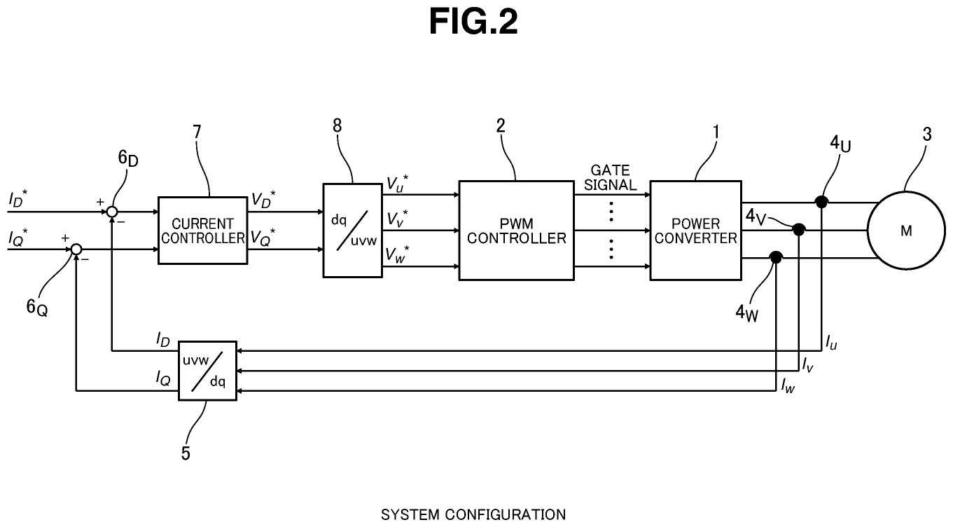

FIG. 2 illustrates an example of a system configuration to which a phase correction method for synchronous PWM control according to the present invention is applied. A reference symbol 1 denotes a power converter (a three-phase inverter) in which PWM control is performed by a gate signal generated by comparing an output voltage command and a carrier signal in a PWM controller 2.

An output voltage of the power converter 1 is supplied to a motor 3. Reference symbols 4_{U}, 4_{V}, 4_{W} denote current sensors for detecting three-phase output currents I_{U}, I_{V}, I_{W} of the power converter 1. A reference symbol 5 denotes a uvw/dq converter that converts the detected three-phase output currents I_{U}, I_{V}, I_{W} into a d-axis current Ip and a q-axis current I_{Q} in a dq coordinate system.

A reference symbol 6_{D}, denotes a subtractor that takes a deviation between a d-axis current command I_{D}* and the d-axis current I_{D}. A reference symbol 6, denotes a subtractor that takes a deviation between a q-axis current command I_{Q}* and the q-axis current I_{Q}.

A reference symbol 7 denotes a current controller that calculates dq-axis voltage commands V_{D}*, V_{Q}* so that deviation outputs of 6p and 60 each become zero (so that I_{D} and I_{Q} follow I_{D}* and I_{Q}*).

A reference symbol 8 denotes a dq/uvw converter that coordinate-converts the dq-axis voltage commands V_{D}*, V_{Q}* output from the current controller 7 into three-phase voltage commands V_{U}*, V_{V}*, V_{W}*, and provides them to the PWM controller 2.

The PWM controller 2 is a generally widely adopted triangular wave comparison PWM type. The PWM controller 2 switches between asynchronous PWM control and synchronous PWM control according to an output frequency. A carrier frequency of synchronous PWM control is set to an integer multiple of three of the output frequency, and the number of pulses Kp (the number of pulses of the carrier signal per cycle of the output voltage command) satisfying an expression (1) is determined.

$$\begin{matrix}[ Expression 1 ] & \\ {K}_{p} = ( 2 n + 1 ) \times 3 & ( 1 )\end{matrix}$$

Here, n is an integer (n=0, 1, 2, . . . ).

Although an upper limit of the carrier frequency differs depending on a power converter, in a case of the power converter 1 in the present specification, the upper limit of the carrier frequency is set to 8000 Hz.

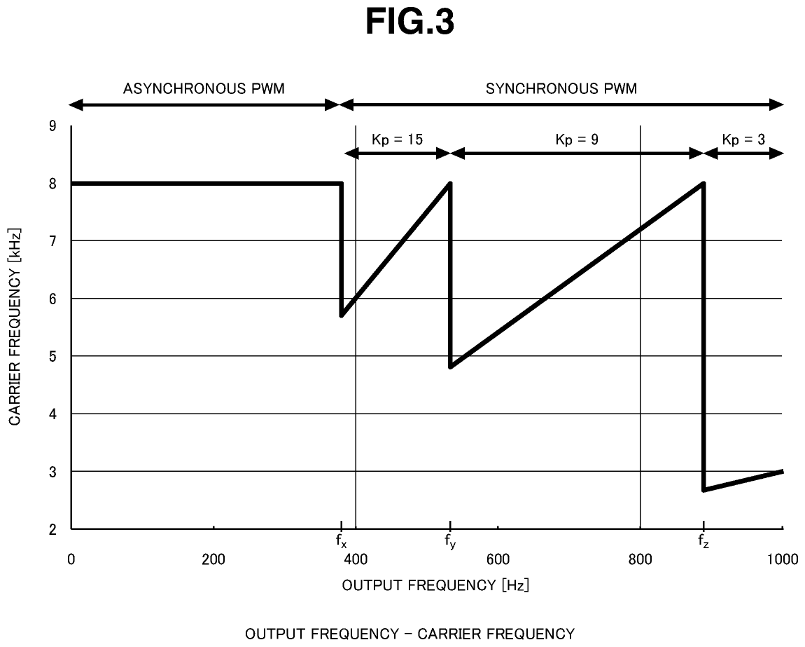

FIG. 3 illustrates an example of the carrier frequency used for PWM control with the output frequency of 0 to 1000 Hz. It is noted that when performing asynchronous PWM control, the carrier frequency is fixed at 8000 Hz of the upper limit. Regarding the switching from asynchronous PWM control to synchronous PWM control, when the output frequency becomes an output frequency fₓ (8000/21≈380.95 Hz) at which the number of pulses of an output voltage cannot secure 21 pulses which is determined when n=3 in the expression (1), asynchronous PWM control is switched to synchronous PWM control with 15 pulses which is determined when n=2 in the expression (1).

Furthermore, when the output frequency becomes an output frequency f_{y} (8000/15≈533.33 Hz) at which the number of pulses of the output voltage cannot secure 15 pulses which is determined when n=2 in the expression (1), the control is switched to synchronous PWM control with 9 pulses which is determined when n=1 in the expression (1). Likewise, when the output frequency becomes an output frequency f_{z} (8000/9=888.88 Hz) at which the number of pulses of the output voltage cannot secure 9 pulses which is determined when n=1 in the expression (1), the control is switched to synchronous PWM control with 3 pulses which is determined when n=0 in the expression (1).

The carrier frequency f_{c} [Hz] in synchronous PWM control is determined from multiplication of the number of pulses Kp and the output frequency f_{O} [Hz], as indicated in an expression (2).

$$\begin{matrix}[ Expression 2 ] & \\ {f}_{c} = {K}_{p} \times {f}_{o} & ( 2 )\end{matrix}$$

For instance, when the output frequency fₒ is 600 Hz, the carrier frequency f_{c} is 5400 Hz (=9×600).

### First Embodiment

Whether a phase of the output voltage command and a phase of the carrier signal are synchronized can be determined by sampling the phase of the output voltage command at a periodic timing synchronized with the carrier signal.

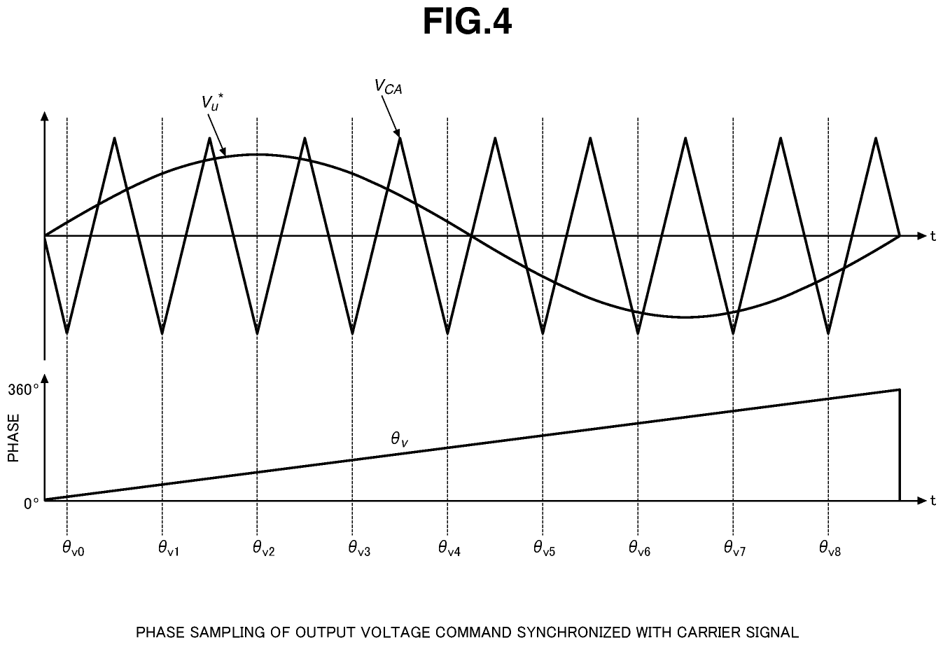

FIG. 4 illustrates the sampling of the phase of the output voltage command synchronized with the carrier signal, in synchronous PWM control with 9 pulses (the number of pulses Kp is 9). In the drawing, θ_{V} is a phase of the output voltage command. In an example shown in FIG. 4, the sampling is performed at a trough (valley) of a triangular wave that is the carrier signal. However, the sampling timing could be changed to a crest (peak) or a zero point of the triangular wave.

In a case where the sampling is set so as to occur once per cycle of the carrier signal, when the number of pulses Kp is 9 (9 pulses) in synchronous PWM control, as shown in FIG. 4, the sampling is performed nine times for one cycle of the output voltage command. To identify the nine sampled phases, numbers 0 to 8 are added to numerical subscripts.

Although there are several possible definitions of phase synchronization between the output voltage command and the carrier signal, this time, as illustrated in FIG. 4, a state in which a phase θ degree of the output voltage command and a zero point during the transition from the peak to the valley of the triangular wave that is the carrier signal coincide with each other, is defined as the phase synchronization.

When the phases of the output voltage command and the carrier signal are synchronized with each other, the sampled phases θ_{V0} to θ_{V8} of the output voltage command are uniquely determined. A synchronous phase θ′_{V0} of θ_{V0} when the number of pulses is Kp in synchronous PWM control is derived from the following expression (3).

$$[ Expression 3 ]$$

$${θ}_{v 0}^{′} = \frac{360}{{K}_{p} \times 4} [ deg ] \qquad ( 3 )$$

Although synchronous phases of the other θ_{V1} to θ_{V8} can also be determined, since θ_{V0} necessarily exists for any number of pulses in synchronous PWM control (for instance, when the number of pulses is 15 (15 pulses), θ_{V0} to θ_{V14} exist, but when the number of pulses is 9 (9 pulses), θ_{V0} to θ_{V8} exist, and θ_{V9} or later do not exist), the synchronous phase θ′_{V0} which can be determined from the expression (3) is set as a reference, and a phase synchronous state is determined by an error between this synchronous phase θ′_{V0} and the actual θ_{V0} (a detected phase).

For instance, when the number of pulses is 9 (9 pulses), the synchronous phase θ′_{V0} is determined as 10 degrees from the expression (3). If the actual θ_{V0} is also 10 degrees, there is no phase error, and the phase is synchronized, but if θ_{V0} is 15 degrees, this means that there is a phase error of +5 degrees from the synchronous state.

In the phase correction method according to the present invention, when the phase error from this defined synchronous state exceeds a certain threshold value, the carrier frequency is changed from a value of an integer multiple of the output frequency of the expression (2) to a phase correction carrier frequency. The threshold value of the phase error, which is a condition for performing the phase correction, is, for instance, ±5 degrees.

The phase correction carrier frequency f_{cθ} is calculated by the following expression (4).

$$[ Expression 4 ]$$

$${f}_{c θ} = \frac{360 \times {f}_{o}}{360 - {θ}_{err}} \times {K}_{p} [ Hz ] \qquad ( 4 )$$

Here, θₑᵣᵣ is a difference between the synchronous phase θ′_{V0} and the actual phase θ_{V0}, and is calculated by the following expression (5).

$$[ Expression 5 ]$$

$${θ}_{err} = {θ}_{v 0} - {θ}_{v 0}^{′} [ deg ] \qquad ( 5 )$$

At Kp^{th} cycle or after Kp cycles of the carrier signal, the phase correction carrier frequency f_{cθ} is returned again to the carrier frequency f_{c} calculated by the expression (2).

For instance, when the output frequency is 600 Hz and the number of pulses in the synchronous PWM control is 9 (9 pulses), the carrier frequency is normally 5400 Hz (=9×600) calculated from the expression (2). If the phase error θₑᵣᵣ becomes+5 degrees during the operation, the carrier frequency is changed to approximately 5476 Hz that is the phase correction carrier frequency calculated by the expression (4). At 9^{th} cycle or after 9 cycles of the carrier signal after the change, the carrier frequency (the phase correction carrier frequency) is returned again to 5400 Hz.

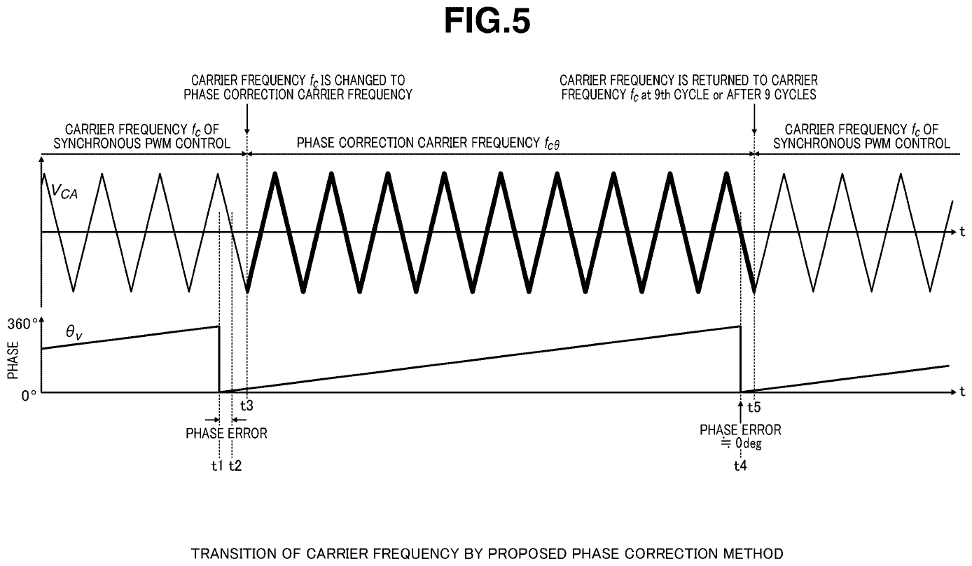

FIG. 5 illustrates transition of the carrier frequency by the phase correction method according to the present invention. V_{CA} in an upper part in FIG. 5 indicates the carrier signal, and θ_{V} in a lower part indicates a phase of the output voltage command. The number of pulses for the synchronous PWM control is set to 9 (9 pulses).

In FIG. 5, during the operation at the carrier frequency f_{c} in synchronous PWM control, time t1 at which the phase θ_{V} of the output voltage command is 0 degree and time t2 at which the carrier signal is a zero point during the transition from the peak to the valley of the carrier signal do not coincide with each other, and thus a phase error exists. If the phase error exceeds the threshold value for performing the phase correction, at time t3, the carrier frequency f_{c} is changed to the phase correction carrier frequency f_{cθ} calculated by the expression (4). At time t5 at 9th cycle or after 9 cycles of the carrier signal after the change, the carrier frequency (the phase correction carrier frequency) is returned to the carrier frequency f_{c} calculated from the expression (2). At this time, as shown at time t4, the phase error has almost disappeared, and the carrier frequency has been corrected to a state in which the phase of the output voltage command and the phase of the carrier signal are synchronized with each other.

In order to realize the phase correction method shown in FIG. 5, a phase correction device of the first embodiment includes a phase error detection unit, a first carrier frequency calculation unit, and a carrier frequency setting unit, which will be described below.

The phase error detection unit detects an error between a phase (a detected phase θ_{V0} acquired by the sampling) of the output voltage command of the power converter 1 operating under synchronous PWM control and a synchronous phase θ′_{V0} calculated by the expression (3), which corresponds to the phase of the carrier signal of the carrier frequency in synchronous PWM control.

The first carrier frequency calculation unit calculates, by the expression (4), a first phase correction carrier frequency fee for correcting the phase error, when the detected phase error (the error between θ_{V0} and θ′_{V0}) exceeds the set threshold value.

The carrier frequency setting unit sets a carrier frequency (f_{c} of the expression (2)) in synchronous PWM control during the operation under synchronous PWM control, and when the detected phase error exceeds the set threshold value, changes and sets the carrier frequency of the carrier signal to the first phase correction carrier frequency (f_{cθ} of the expression (4)) for a set period (Kp cycles).

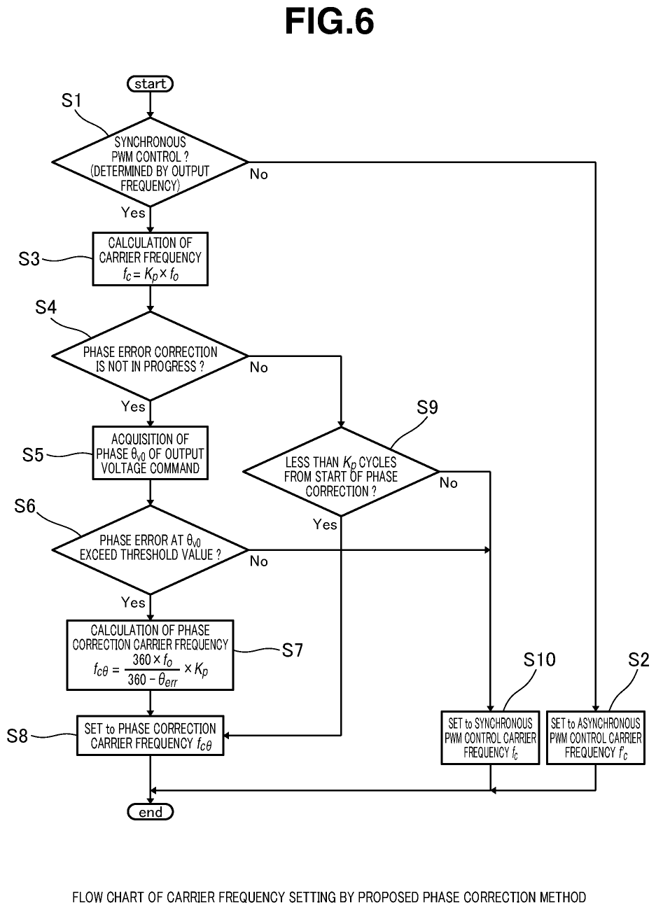

Next, a flow chart of carrier frequency setting performed by the phase correction device according to the first embodiment during the operation of the power converter 1 will be described with reference to FIG. 6. In FIG. 6, first, in step S1, it is determined, by the output frequency, whether the operation is performed under asynchronous PWM control or synchronous PWM control. If the operation is performed under asynchronous PWM control (if the determination result in step S1 is No), in step S2, the carrier frequency is set to an asynchronous PWM control carrier frequency f′c.

If the operation is performed under synchronous PWM control (if the determination result in step S1 is Yes), in step S3, in the normal state, a value (f_{c}) of an integer multiple of the output frequency, which is calculated from the expression (2), is set as the carrier frequency.

Next, in step S4, it is determined whether or not the phase error correction is not in progress. If the phase error correction is not in progress, in step S5, in order to determine the synchronous state, the phase θ_{V0} (the detected phase θ_{V0}) of the output voltage command is acquired by the sampling.

Next, in step S6, it is determined whether or not a phase error between the detected phase evo and the synchronous phase θ′_{V0} calculated by the expression (3) exceeds the threshold value. If the determination result in step S6 is “the phase error exceeds the threshold value”, in step S7, the first phase correction carrier frequency fee is determined by calculating the expression (4). Further, in step S8, the carrier frequency is changed and set to the first phase correction carrier frequency f_{cθ}.

If it is determined in the determination process in step S4 that the phase error correction is in progress, in step S9, it is determined whether or not the cycles from a start of the phase correction are less than Kp.

As long as the determination result in step S9 is less than Kp cycles, setting of the first phase correction carrier frequency f_{cθ} remains as it is by the execution of step S8. If the Kp cycles have elapsed (if the determination result in step S9 is No), in step S10, the carrier frequency is set again to the carrier frequency f_{c} calculated by the expression (2).

By performing the phase correction in this manner, even when the phase error between the output voltage command and the carrier signal occurs during the operation under synchronous PWM control, the phase synchronous state can be maintained by temporarily changing the carrier frequency.

The configuration shown in FIG. 2, to which the present invention is applied, is an example of configuration in the case of the power converter 1 with the motor 3 as the load, i.e. in the case of the three-phase inverter (a DC/AC converter). However, the present invention is not limited to this configuration, and could be applied to a case of a load other than the motor, or may be applied to a case of a single-phase inverter. That is, the present invention can be applied to cases of all power converters having the carrier frequency.

### Second Embodiment

There is an upper limit to the carrier frequency due to relationships with loss and temperature rise of switching elements which occur upon switching, and with an operation speed of a control circuit that generates the carrier signal, etc. As in the first embodiment, when calculating the first phase correction carrier frequency f_{cθ} by the expression (4), there is a possibility that the carrier frequency will exceed an upper limit of the carrier frequency which is limited by the power converter depending on conditions of the output frequency and/or the phase error. As mentioned above, the upper limit of the carrier frequency of the target power converter is set to 8000 Hz. When calculating the expression (4) with the output frequency being 880 Hz (the number of pulses Kp in synchronous PWM control is 9 (9 pulses)) and the phase error being +5 degrees, the phase correction carrier frequency is approximately 8031 Hz, which exceeds the upper limit.

Therefore, in a second embodiment, the phase is corrected while preventing the carrier frequency from exceeding the upper limit of the carrier frequency of the power converter. That is, when the calculation result of the expression (4) exceeds the upper limit of the carrier frequency, the phase correction carrier frequency is recalculated by the following expression (6).

$$[ Expression 6 ]$$

$${f}_{c θ} = \frac{360 \times {f}_{o}}{360 - {θ}_{err}} \times ( {K}_{p} - 1 ) [ Hz ] \qquad ( 6 )$$

The phase error θₑᵣᵣ is determined by the expression (5), in the same manner as the case of the expression (4).

When calculating the phase correction carrier frequency using the expression (6) with the output frequency being 880 Hz and the phase error being +5 degrees, it is approximately 7139 Hz, which does not exceed the upper limit 8000 Hz of the carrier frequency of the power converter. At (Kp−1)^{th} cycle or after (Kp−1) cycles of the carrier signal, the carrier frequency (the phase correction carrier frequency) is returned to carrier frequency calculated by the expression (2). A timing of returning the carrier frequency from the phase correction carrier frequency to the original carrier frequency that is an integer multiple of the output frequency differs depending on whether the expression (4) is applied and the return is executed at Kp^{th} cycle or after Kp cycles of the carrier signal or the expression (6) is applied and the return is executed at (Kp−1)^{th} cycle or after (Kp−1) cycles of the carrier signal. For this reason, it is necessary to prepare a discrimination flag etc. to determine which expression (equation) is used to calculate the carrier frequency for performing the phase correction.

In order to realize the above phase correction method, a phase correction device of the second embodiment includes a phase error detection unit, a first carrier frequency calculation unit, a second carrier frequency calculation unit, and a carrier frequency setting unit, which will be described below.

As in the first embodiment, the phase error detection unit detects an error between a phase (a detected phase θ_{V0} acquired by the sampling) of the output voltage command of the power converter 1 operating under synchronous PWM control and a synchronous phase θ′_{V0} calculated by the expression (3), which corresponds to the phase of the carrier signal of the carrier frequency in synchronous PWM control.

The first carrier frequency calculation unit calculates, by the expression (4), a first phase correction carrier frequency fee for correcting the phase error, when the detected phase error (the error between θ_{V0} and θ′_{V0}) exceeds the set threshold value.

The second carrier frequency calculation unit determines whether or not the first phase correction carrier frequency calculated by the expression (4) exceeds the upper limit of the carrier frequency of the power converter 1, and when the first phase correction carrier frequency exceeds the upper limit, calculates a second phase correction carrier frequency (fee of the expression (6)) for correcting the phase error, which does not exceed the upper limit of the carrier frequency of the power converter 1.

The carrier frequency setting unit changes and sets, when the first phase correction carrier frequency (f_{cθ} of the expression (4)) does not exceed the upper limit of the carrier frequency of the power converter 1, the carrier frequency of the carrier signal to the first phase correction carrier frequency (fee of the expression (4)) for a set period (Kp cycles), and when the first phase correction carrier frequency exceeds the upper limit of the carrier frequency of the power converter 1, changes and sets the carrier frequency of the carrier signal to the second phase correction carrier frequency (f_{cθ} of the expression (6)) for a set period ((Kp−1) cycles).

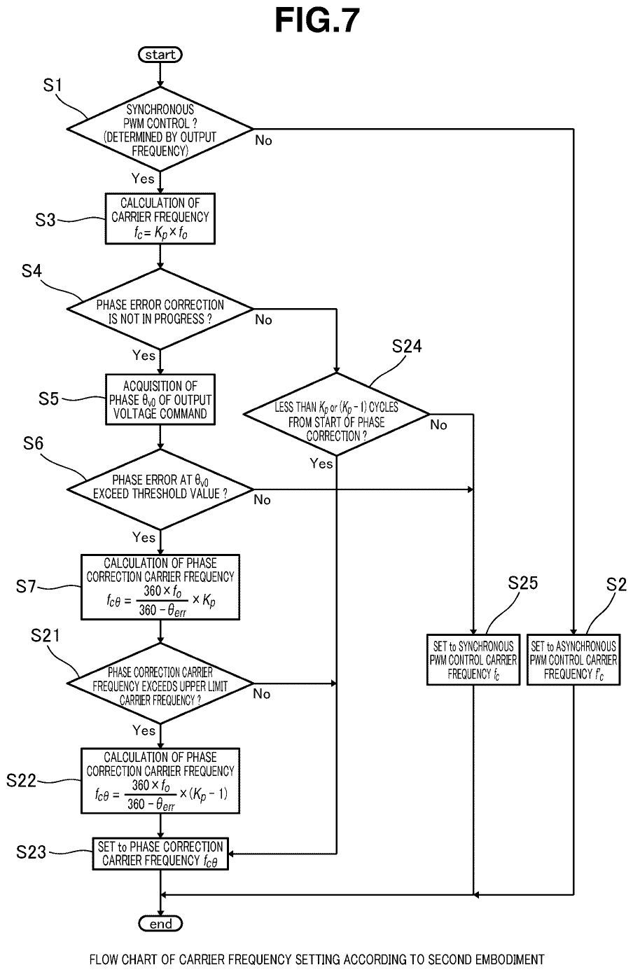

Next, a flow chart of carrier frequency setting performed by the phase correction device according to the second embodiment during the operation of the power converter 1 will be described with reference to FIG. 7. In FIG. 7, in steps S1 to S7, the same processing as steps S1 to S7 of FIG. 6 are executed. That is, first, in step S1, it is determined, by the output frequency, whether the operation is performed under asynchronous PWM control or synchronous PWM control. If the operation is performed under asynchronous PWM control (if the determination result in step S1 is No), in step S2, the carrier frequency is set to an asynchronous PWM control carrier frequency f′c.

If the operation is performed under synchronous PWM control (if the determination result in step S1 is Yes), in step S3, in the normal state, a value (f_{c}) of an integer multiple of the output frequency, which is calculated from the expression (2), is set as the carrier frequency.

Next, in step S4, it is determined whether or not the phase error correction is not in progress. If the phase error correction is not in progress, in step S5, in order to determine the synchronous state, the phase θ_{V0} (the detected phase θ_{V0}) of the output voltage command is acquired by the sampling.

Next, in step S6, it is determined whether or not a phase error between the detected phase θ_{V0} and the synchronous phase θ′_{V0} calculated by the expression (3) exceeds the threshold value. If the determination result in step S6 is “the phase error exceeds the threshold value”, in step S7, the first phase correction carrier frequency f_{cθ} is determined by calculating the expression (4).

Next, in step S21, it is determined whether or not the first phase correction carrier frequency calculated in step S7 exceeds the upper limit carrier frequency of the power converter. If the determination result in step S21 is Yes, in step S22, the second phase correction carrier frequency (f_{cθ}) of the expression (6) is calculated. Then, in step S23, the second phase correction carrier frequency (f_{cθ}) calculated by the expression (6) is set.

If the determination result in step S21 is No (if the first phase correction carrier frequency does not exceed the upper limit carrier frequency of the power converter), in step S23, the first phase correction carrier frequency f_{cθ} is set.

If the determination result in step S4 is No (if the phase error correction is in progress), in step S24, it is determined whether the cycles from a start of the phase correction are less than Kp or (Kp−1).

In this step S24, the discrimination flag for determining whether the phase correction is being performed by applying the first phase correction carrier frequency of the expression (4) or the second phase correction carrier frequency of the expression (6) is prepared. If the phase correction by the expression (4) is being performed, it is determined whether or not the cycles are less than Kp. If the phase correction by the expression (6) is being performed, it is determined whether or not the cycles are less than (Kp−1).

If the determination result in step S24 is Yes, the routine is returned to step S23. If the determination result in step S24 is No (if Kp or (Kp−1) cycles have elapsed), in step S25, the carrier frequency is set again to the carrier frequency f_{c} calculated by the expression (2).

When the calculation result of the expression (4) exceeds the upper limit of the carrier frequency of the power converter as in the first embodiment, for instance, if the carrier frequency is limited by the upper limit, the phase correction is not accurately performed. In the second embodiment, since the second phase correction carrier frequency which does not exceed the upper limit of the carrier frequency is set, the phase correction is accurately performed.

### Third Embodiment

In the first embodiment, the condition for changing the carrier frequency to the first phase correction carrier frequency fee is the phase error of ±5 degrees as the threshold value. However, for instance, when the output frequency fluctuates, a large phase error may occur. In such a case, there is a large difference between the carrier frequency (f_{c}) calculated by the expression (2), which is a value of an integer multiple of the output frequency, and the first phase correction carrier frequency (f_{cθ}) calculated by the expression (4). If a range of change in the carrier frequency (a variation range of the carrier frequency) is large, an excessive current (a current shock) flows upon switching the carrier frequency.

Therefore, in the third embodiment, a limit is placed on the range of change in the carrier frequency, and the phase is corrected while suppressing the current shock. When a difference between the carrier frequency f_{c} that is the calculation result of the expression (2) and the first phase correction carrier frequency f_{cθ} that is the calculation result of the expression (4) is greater than a certain threshold value fₗᵢₘ (a variation range limit value) Hz, in order to limit the variation range to fₗᵢₘ, the carrier frequency is set to a carrier frequency f′_{cθ} (a third phase correction carrier frequency) of the following expression (7).

$$[ Expression 7 ]$$

$${f}_{c θ}^{′} = {f}_{c \_ z} \pm {f}_{lim} [ Hz ] \qquad ( 7 )$$

Here, f_{c_z} in the expression (7) is a currently set carrier frequency. Whether to add or subtract the variation range limit value fₗᵢₘ of the expression (7) is determined by the following expression (8), depending on the magnitude relationship of the first phase correction carrier frequency f_{cθ} that is the calculation result of the expression (4).

$$[ Expression 8 ]$$

$$\{ \begin{matrix}{f}_{c \_ z} > {f}_{c θ} : {f}_{lim} & SUBTRACTION \\ {f}_{c \_ z} < {f}_{c θ} : {f}_{lim} & ADDITION\end{matrix} \qquad ( 8 )$$

For instance, the variation range limit value fₗᵢₘ is set to 500 Hz (the variation range limit value fₗᵢₘ=500 Hz). Further, it is assumed that, during the operation at the carrier frequency 2700 Hz calculated from the expression (2), the first phase correction carrier frequency calculated from the expression (4) is 3600 Hz. A difference between 2700 Hz and 3600 Hz is 900 Hz, which exceeds the variation range limit value 500 Hz. In this case, the carrier frequency is changed to 3200 Hz (=2700+500) calculated by the expression (7).

At Kp^{th} cycle or after Kp cycles of the carrier signal, the carrier frequency is returned to the carrier frequency f_{c} calculated by the expression (2). At this time, if the phase error between the output voltage command and the carrier signal still exceeds the threshold value ±5 degrees, the first phase correction carrier frequency is calculated by the expression (4). A determination is also made as to whether the range of change in the carrier frequency exceeds 500 Hz of the variation range limit value. Thereafter, these processing are repeated until the phase correction is performed such that the phase error is equal to or smaller than the threshold value.

In order to realize the above phase correction, a phase correction device of the third embodiment includes a phase error detection unit, a first carrier frequency calculation unit, a third carrier frequency calculation unit, and a carrier frequency setting unit, which will be described below.

As in the first embodiment, the phase error detection unit detects an error between a phase (a detected phase θ_{V0} acquired by the sampling) of the output voltage command of the power converter 1 operating under synchronous PWM control and a synchronous phase θ′_{V0} calculated by the expression (3), which corresponds to the phase of the carrier signal of the carrier frequency in synchronous PWM control.

The first carrier frequency calculation unit calculates, by the expression (4), a first phase correction carrier frequency fee for correcting the phase error, when the detected phase error (the error between θ_{V0} and θ′_{V0}) exceeds the set threshold value.

The third carrier frequency calculation unit determines whether or not the difference between the first phase correction carrier frequency f_{cθ} calculated by the expression (4) and the carrier frequency f_{c} z having been set by the carrier frequency setting unit exceeds the set variation range limit value fₗᵢₘ, and when the difference exceeds the variation range limit value fₗᵢₘ, calculates the third phase correction carrier frequency f′_{cθ} by adding or subtracting the variation range limit value fₗᵢₘ to or from the carrier frequency having been set by the carrier frequency setting unit.

The carrier frequency setting unit changes and sets, when the detected phase error exceeds the set threshold value but the difference between the first phase correction carrier frequency f_{cθ} and the carrier frequency having been set by the carrier frequency setting unit does not exceed the variation range limit value fₗᵢₘ, the carrier frequency of the carrier signal to the first phase correction carrier frequency f_{cθ} for a set period (Kp cycles), and when the detected phase error exceeds the set threshold value and also the difference between the first phase correction carrier frequency f_{cθ} and the carrier frequency having been set by the carrier frequency setting unit exceeds the variation range limit value fₗᵢₘ, changes and sets the carrier frequency of the carrier signal to the third phase correction carrier frequency f′_{cθ} for a set period.

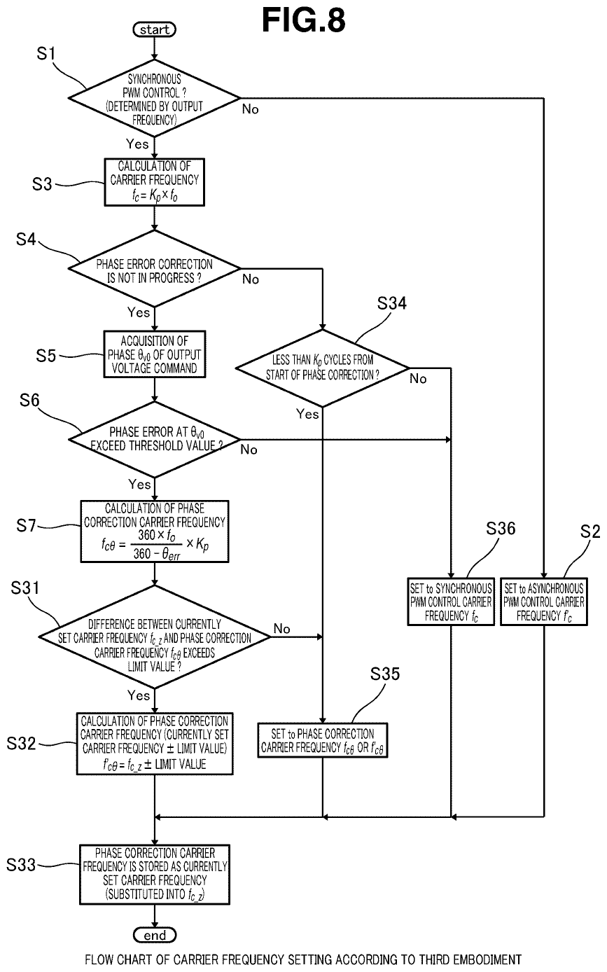

Next, a flow chart of carrier frequency setting performed by the phase correction device according to the third embodiment during the operation of the power converter 1 will be described with reference to FIG. 8. In FIG. 8, in steps S1 to S7, the same processing as steps S1 to S7 of FIG. 6 are executed. That is, first, in step S1, it is determined, by the output frequency, whether the operation is performed under asynchronous PWM control or synchronous PWM control. If the operation is performed under asynchronous PWM control (if the determination result in step S1 is No), in step S2, the carrier frequency is set to an asynchronous PWM control carrier frequency f′_{c}.

If the operation is performed under synchronous PWM control (if the determination result in step S1 is Yes), in step S3, in the normal state, a value (f_{c}) of an integer multiple of the output frequency, which is calculated from the expression (2), is set as the carrier frequency.

Next, in step S4, it is determined whether or not the phase error correction is not in progress. If the phase error correction is not in progress, in step S5, in order to determine the synchronous state, the phase θ_{V0} (the detected phase θ_{V0}) of the output voltage command is acquired by the sampling.

Next, in step S6, it is determined whether or not a phase error between the detected phase θ_{V0} and the synchronous phase θ′_{V0} calculated by the expression (3) exceeds the threshold value. If the determination result in step S6 is “the phase error exceeds the threshold value”, in step S7, the first phase correction carrier frequency f_{cθ} is determined by calculating the expression (4).

Next, in step S31, it is determined whether or not the difference between the currently set carrier frequency f_{C_Z} and the first phase correction carrier frequency f_{cθ} exceeds the variation range limit value fₗᵢₘ.

If the determination result in step S31 is “the difference exceeds the variation range limit value fₗᵢₘ” in step S32, the third phase correction carrier frequency f′cθ (the expression (7) and the expression (8)) is calculated by adding or subtracting the variation range limit value fₗᵢₘ to or from the currently set carrier frequency f_{C_Z}. Further, in step S33, the third phase correction carrier frequency f′_{cθ} is stored as a currently set carrier frequency (the third phase correction carrier frequency f′_{cθ} is substituted into f_{C_Z}).

If the determination result in step S4 is No (if the phase error correction is in progress), in step S34, it is determined whether or not the cycles from a start of the phase correction are less than Kp. If the determination result in step S34 is Yes, or, if the determination result in step S31 is No (the difference between f_{c} z and f_{cθ} does not exceed fₗᵢₘ), in step S35, the first phase correction carrier frequency f_{cθ} or the third phase correction carrier frequency f′_{cθ} is set. Further, in step S33, the first phase correction carrier frequency f_{cθ} or the third phase correction carrier frequency f′_{cθ} is stored as a currently set carrier frequency.

If the determination result in step S34 is No (if Kp cycles have elapsed), in step S36, the carrier frequency is set again to the carrier frequency f_{c} calculated by the expression (2).

When a large difference between the calculation result of the expression (4) and the currently set carrier frequency arises as in the first embodiment, the current shock may occur. In the third embodiment, the limit is placed on the range of change in the carrier frequency, thereby performing the phase correction while suppressing the current shock.

### DESCRIPTION OF REFERENCE SYMBOLS

1 . . . power converter
2 . . . PWM controller
3 . . . motor
4u, 4v, 4w . . . current sensor
5 . . . uvw/dq converter
6_{D}, 6_{Q} . . . subtractor
7 . . . current controller
8 . . . dq/uvw converter

1.-9. (canceled)

10. A phase correction device for synchronous PWM control for controlling a single-phase or three-phase power converter with a phase of an output voltage command and a phase of a carrier signal being synchronized with each other, the phase correction device comprising:
a phase error detection unit configured to detect an error between a phase of the output voltage command of the power converter operating under the synchronous PWM control and a phase of the carrier signal of a carrier frequency in the synchronous PWM control;
a first carrier frequency calculation unit configured to, when the detected phase error exceeds a set threshold value, calculate a first phase correction carrier frequency for correcting the phase error;
a carrier frequency setting unit configured to set the carrier frequency in the synchronous PWM control during operation under the synchronous PWM control, and when the detected phase error exceeds the set threshold value, change and set the carrier frequency of the carrier signal to the first phase correction carrier frequency for a set period; and
a second carrier frequency calculation unit configured to determine whether or not the calculated first phase correction carrier frequency exceeds an upper limit of the carrier frequency of the power converter, and when the first phase correction carrier frequency exceeds the upper limit, calculate a second phase correction carrier frequency for correcting the phase error, which does not exceed the upper limit of the carrier frequency of the power converter,
wherein the carrier frequency setting unit is configured to, when the first phase correction carrier frequency does not exceed the upper limit of the carrier frequency of the power converter, change and set the carrier frequency of the carrier signal to the first phase correction carrier frequency for the set period, and when the first phase correction carrier frequency exceeds the upper limit of the carrier frequency of the power converter, change and set the carrier frequency of the carrier signal to the second phase correction carrier frequency for another set period.

11. A phase correction device for synchronous PWM control for controlling a single-phase or three-phase power converter with a phase of an output voltage command and a phase of a carrier signal being synchronized with each other, the phase correction device comprising:
a phase error detection unit configured to detect an error between a phase of the output voltage command of the power converter operating under the synchronous PWM control and a phase of the carrier signal of a carrier frequency in the synchronous PWM control;
a first carrier frequency calculation unit configured to, when the detected phase error exceeds a set threshold value, calculate a first phase correction carrier frequency for correcting the phase error;
a carrier frequency setting unit configured to set the carrier frequency in the synchronous PWM control during operation under the synchronous PWM control, and when the detected phase error exceeds the set threshold value, change and set the carrier frequency of the carrier signal to the first phase correction carrier frequency for a set period; and
a third carrier frequency calculation unit configured to determine whether or not a difference between the calculated first phase correction carrier frequency and the carrier frequency having been set by the carrier frequency setting unit exceeds a set variation range limit value, and when the difference exceeds the variation range limit value, calculate a third phase correction carrier frequency by adding or subtracting the variation range limit value to or from the carrier frequency having been set by the carrier frequency setting unit,
wherein the carrier frequency setting unit is configured to, when the detected phase error exceeds the set threshold value but the difference between the first phase correction carrier frequency and the carrier frequency having been set by the carrier frequency setting unit does not exceed the variation range limit value, change and set the carrier frequency of the carrier signal to the first phase correction carrier frequency for the set period, and when the detected phase error exceeds the set threshold value and also the difference between the first phase correction carrier frequency and the carrier frequency having been set by the carrier frequency setting unit exceeds the variation range limit value, change and set the carrier frequency of the carrier signal to the third phase correction carrier frequency for another set period.

12. A phase correction device for synchronous PWM control for controlling a single-phase or three-phase power converter with a phase of an output voltage command and a phase of a carrier signal being synchronized with each other, the phase correction device comprising:
a phase error detection unit configured to detect an error between a phase of the output voltage command of the power converter operating under the synchronous PWM control and a phase of the carrier signal of a carrier frequency in the synchronous PWM control;
a first carrier frequency calculation unit configured to, when the detected phase error exceeds a set threshold value, calculate a first phase correction carrier frequency for correcting the phase error; and
a carrier frequency setting unit configured to set the carrier frequency in the synchronous PWM control during operation under the synchronous PWM control, and when the detected phase error exceeds the set threshold value, change and set the carrier frequency of the carrier signal to the first phase correction carrier frequency for a set period,
wherein
the carrier frequency setting unit is configured to set a carrier frequency f_{c} in the synchronous PWM control, as f_{c}=Kp×fₒ (Kp is the number of pulses of the carrier signal per cycle of the output voltage command, and fₒ is the output frequency of the power converter),
the phase error detection unit is configured to
define a synchronous phase θ′_{V0} of the phase of the output voltage command at a set reference point when the phases of the output voltage command and the carrier signal are synchronized with each other and the number of pulses is Kp, by the following expression (3), and
$$[ Expression 3 ]$$
$${θ}_{v 0}^{′} = \frac{360}{{K}_{p} \times 4} [ deg ] \qquad ( 3 )$$
detect an error between a detected phase θ_{V0} of the output voltage command at the set reference point and the synchronous phase θ′_{V0} defined by the expression (3),
the first carrier frequency calculation unit is configured to calculate a first phase correction carrier frequency f_{cθ} by the following expressions (4) and (5),
$$[ Expression 4 ]$$
$${f}_{c θ} = \frac{360 \times {f}_{o}}{360 - {θ}_{err}} \times {K}_{p} [ Hz ] \qquad ( 4 )$$
$$[ Expression 5 ]$$
$${θ}_{err} = {θ}_{v 0} - {θ}_{v 0}^{′} [ deg ] \qquad ( 5 )$$
(here, θₑᵣᵣ is a difference between the synchronous phase θ′_{V0} and the detected phase θ_{V0}), and
the period for which the carrier frequency of the carrier signal is changed and set to the first phase correction carrier frequency by the carrier frequency setting unit is Kp cycles of the carrier signal.

13. The phase correction device for the synchronous PWM control as claimed in claim 10, wherein
the carrier frequency setting unit is configured to set a carrier frequency f_{c} in the synchronous PWM control, as f_{c}=Kp×fₒ (Kp is the number of pulses of the carrier signal per cycle of the output voltage command, and fₒ is the output frequency of the power converter),
the phase error detection unit is configured to
define a synchronous phase θ′_{V0} of the phase of the output voltage command at a set reference point when the phases of the output voltage command and the carrier signal are synchronized with each other and the number of pulses is Kp, by the following expression (3), and
$$[ Expression 3 ]$$
$${θ}_{v 0}^{′} = \frac{360}{{K}_{p} \times 4} [ deg ] \qquad ( 3 )$$
detect an error between a detected phase θ_{V0} of the output voltage command at the set reference point and the synchronous phase θ′_{V0} defined by the expression (3),
the first carrier frequency calculation unit is configured to calculate a first phase correction carrier frequency fee by the following expressions (4) and (5),
$$[ Expression 4 ]$$
$${f}_{c θ} = \frac{360 \times {f}_{o}}{360 - {θ}_{err}} \times {K}_{p} [ Hz ] \qquad ( 4 )$$
$$[ Expression 5 ]$$
$${θ}_{err} = {θ}_{v 0} - {θ}_{v 0}^{′} [ deg ] \qquad ( 5 )$$
(here, θₑᵣᵣ is a difference between the synchronous phase θ′_{V0} and the detected phase θ_{V0}), and
the second carrier frequency calculation unit is configured to calculate a second phase correction carrier frequency fee by the following expressions (6) and (5),
$$[ Expression 6 ]$$
$${f}_{c θ} = \frac{360 \times {f}_{o}}{360 - {θ}_{err}} \times ( {K}_{p} - 1 ) [ Hz ] \qquad ( 6 )$$
$$[ Expression 5 ]$$
$${θ}_{err} = {θ}_{v 0} - {θ}_{v 0}^{′} [ deg ] \qquad ( 5 )$$
(here, θₑᵣᵣ is a difference between the synchronous phase θ′_{V0} and the detected phase θ_{V0}), and
the period for which the carrier frequency of the carrier signal is changed and set to the first phase correction carrier frequency by the carrier frequency setting unit is Kp cycles of the carrier signal, and the another period for which the carrier frequency of the carrier signal is changed and set to the second phase correction carrier frequency by the carrier frequency setting unit is (Kp−1) cycles of the carrier signal.

14. The phase correction device for the synchronous PWM control as claimed in claim 11, wherein
the carrier frequency setting unit is configured to set a carrier frequency f_{c} in the synchronous PWM control, as f_{c}=Kp×fₒ (Kp is the number of pulses of the carrier signal per cycle of the output voltage command, and fₒ is the output frequency of the power converter),
the phase error detection unit is configured to
define a synchronous phase θ′_{V0} of the phase of the output voltage command at a set reference point when the phases of the output voltage command and the carrier signal are synchronized with each other and the number of pulses is Kp, by the following expression (3), and
$$[ Expression 3 ]$$
$${θ}_{v 0}^{′} = \frac{360}{{K}_{p} \times 4} [ deg ] \qquad ( 3 )$$
detect an error between a detected phase θ_{V0} of the output voltage command at the set reference point and the synchronous phase θ′_{V0} defined by the expression (3),
the first carrier frequency calculation unit is configured to calculate a first phase correction carrier frequency f_{cθ} by the following expressions (4) and (5),
$$[ Expression 4 ]$$
$${f}_{c θ} = \frac{360 \times {f}_{o}}{360 - {θ}_{err}} \times {K}_{p} [ Hz ] \qquad ( 4 )$$
$$[ Expression 5 ]$$
$${θ}_{err} = {θ}_{v 0} - {θ}_{v 0}^{′} [ deg ] \qquad ( 5 )$$
(here, θₑᵣᵣ is a difference between the synchronous phase θ′_{V0} and the detected phase θ_{V0}), and
the third carrier frequency calculation unit is configured to calculate a third phase correction carrier frequency f′_{cθ} by the following expression (7),
$$[ Expression 7 ]$$
$${f}_{c θ}^{′} = {f}_{c \_ z} \pm {f}_{lim} [ Hz ] \qquad ( 7 )$$
(here, f_{C_Z} is a carrier frequency currently set by the carrier frequency setting unit, and fₗᵢₘ is the variation range limit value of the carrier frequency),
addition or subtraction of fₗᵢₘ in the expression (7) is determined by a magnitude relationship indicated in the following expression (8), and
$$[ Expression 8 ]$$
$$\{ \begin{matrix}{f}_{c \_ z} > {f}_{c θ} : {f}_{lim} & SUBTRACTION \\ {f}_{c \_ z} < {f}_{c θ} : {f}_{lim} & ADDITION\end{matrix} \qquad ( 8 )$$
the period for which the carrier frequency of the carrier signal is changed and set to the first phase correction carrier frequency by the carrier frequency setting unit, and the another period for which the carrier frequency of the carrier signal is changed and set to the third phase correction carrier frequency by the carrier frequency setting unit are both Kp cycles of the carrier signal.

15. A phase correction method for synchronous PWM control for controlling a single-phase or three-phase power converter with a phase of an output voltage command and a phase of a carrier signal being synchronized with each other, the phase correction method comprising:
a phase error detection step of detecting an error between a phase of the output voltage command of the power converter operating under the synchronous PWM control and a phase of the carrier signal of a carrier frequency in the synchronous PWM control;
a first carrier frequency calculation step of, when the detected phase error exceeds a set threshold value, calculating a first phase correction carrier frequency for correcting the phase error;
a carrier frequency calculation and setting step of calculating and setting the carrier frequency in the synchronous PWM control during operation under the synchronous PWM control, and a carrier frequency setting change step of, when the phase error detected in the phase error detection step exceeds the set threshold value, changing and setting the carrier frequency of the carrier signal to the first phase correction carrier frequency for a set period; and
a second carrier frequency calculation step of determining whether or not the calculated first phase correction carrier frequency exceeds an upper limit of the carrier frequency of the power converter, and when the first phase correction carrier frequency exceeds the upper limit, calculating a second phase correction carrier frequency for correcting the phase error, which does not exceed the upper limit of the carrier frequency of the power converter,
wherein, in the carrier frequency setting change step, when the first phase correction carrier frequency does not exceed the upper limit of the carrier frequency of the power converter, the carrier frequency of the carrier signal is changed and set to the first phase correction carrier frequency for the set period, and when the first phase correction carrier frequency exceeds the upper limit of the carrier frequency of the power converter, the carrier frequency of the carrier signal is changed and set to the second phase correction carrier frequency for another set period.

16. A phase correction method for synchronous PWM control for controlling a single-phase or three-phase power converter with a phase of an output voltage command and a phase of a carrier signal being synchronized with each other, the phase correction method comprising:
a phase error detection step of detecting an error between a phase of the output voltage command of the power converter operating under the synchronous PWM control and a phase of the carrier signal of a carrier frequency in the synchronous PWM control;
a first carrier frequency calculation step of, when the detected phase error exceeds a set threshold value, calculating a first phase correction carrier frequency for correcting the phase error;
a carrier frequency calculation and setting step of calculating and setting the carrier frequency in the synchronous PWM control during operation under the synchronous PWM control, and a carrier frequency setting change step of, when the phase error detected in the phase error detection step exceeds the set threshold value, changing and setting the carrier frequency of the carrier signal to the first phase correction carrier frequency for a set period; and
a third carrier frequency calculation step of determining whether or not a difference between the calculated first phase correction carrier frequency and the carrier frequency having been set by the carrier frequency calculation and setting step exceeds a set variation range limit value, and when the difference exceeds the variation range limit value, calculating a third phase correction carrier frequency by adding or subtracting the variation range limit value to or from the carrier frequency having been set by the carrier frequency calculation and setting step,
wherein, in the carrier frequency setting change step, when the detected phase error exceeds the set threshold value but the difference between the first phase correction carrier frequency and the carrier frequency having been set by the carrier frequency calculation and setting step does not exceed the variation range limit value, the carrier frequency of the carrier signal is changed and set to the first phase correction carrier frequency for the set period, and when the detected phase error exceeds the set threshold value and also the difference between the first phase correction carrier frequency and the carrier frequency having been set by the carrier frequency calculation and setting step exceeds the variation range limit value, the carrier frequency of the carrier signal is changed and set to the third phase correction carrier frequency for another set period.
